(19) United States
(12) Patent Application Publication
(10) Pub. No.: US 2024/0064876 A1
(43) Pub. Date: Feb. 22, 2024

(54) COOKING SYSTEM AND METHOD FOR INSTALLING A COOKING SYSTEM

(71) Applicant: BSH Hausgeräte GmbH, Munich (DE)

(72) Inventors: Beatriz Arenas Jimenez, La Muela (ES); Noelia Borque Marquina, Zaragoza (ES); Diana Lascorz Pascual, Zaragoza (ES); Damaso Martin Gomez, Zaragoza (ES); Pilar Perez Cabeza, Zaragoza (ES); Fernando Sanz Serrano, Calamocha (Teruel) (ES); María Valencia Betran, Zaragoza (ES); Francisco Villuendas Lopez, Zaragoza (ES)

(21) Appl. No.: 18/265,712

(22) PCT Filed: Nov. 18, 2021
(86) PCT No.: PCT/EP2021/082130

§ 371 Date: Jun. 7, 2023

(30) Foreign Application Priority Data
Dec. 11, 2020 (EP) 20383086

(51) Int. Cl. H05B 6/12

(52) U.S. Cl. CPC H05B 6/1209; H05B 2213/05

(57) ABSTRACT

A cooking system, in particular an induction cooking system, includes a positioning plate, a heating unit arranged below the positioning plate, and a thermal distribution unit designed to distribute. The thermal distribution unit includes a part which is arranged between the positioning plate and the heating unit.

The invention relates to a cooking system as claimed in the preamble of claim 1 and a method for installing a cooking system as claimed in the preamble of claim 15.

A cooking system comprising a positioning plate which is provided for positioning an item of cookware in a positioning region for heating, and comprising a temperature compensation unit which is provided to reduce a temperature gradient of the positioning plate between the positioning region and a region surrounding the positioning region, is already known from the prior art.

The object of the invention, in particular but not limited thereto, is to provide a generic cooking system with improved properties regarding a construction, in particular regarding a heat distribution. The object is achieved according to the invention by the features of claims 1 and 15, while advantageous embodiments and developments of the invention can be derived from the subclaims.

The invention is based on a cooking system, in particular an induction cooking system, comprising at least one positioning plate, comprising at least one heating unit which is arranged below the positioning plate and comprising at least one thermal distribution unit for distributing heat.

It is proposed that at least one part of the thermal distribution unit is arranged between the positioning plate and the heating unit.

Improved properties of the cooking system regarding heat distribution can be achieved by means of such an embodiment. In particular, a thermal load on the positioning plate of the cooking system can be reduced. As a result, in particular, thermal and/or mechanical stresses can be reduced in the positioning plate of the cooking system. Moreover, a service life of the positioning plate can be increased thereby. In particular, it is possible to prevent a rupture and/or breaking of the positioning plate due to thermal and/or mechanical stresses in the positioning plate. Moreover, it is possible to prevent the positioning plate from fracturing into a multiplicity of individual parts in the case of a rupture and/or breaking due to thermal and/or mechanical stresses. In particular, the positioning plate can be held together by means of such an embodiment of the thermal distribution unit, even in the case of a rupture and/or breaking of the positioning plate. As a result, in particular, it is possible to reduce a risk of injury from small fragments of the positioning plate which could potentially be produced. Moreover, a temperature difference relative to the entire positioning plate, which produces mechanical stresses, can be advantageously reduced by means of an embodiment according to the present invention.

The cooking system can be configured at least as a part, in particular as a subassembly, of a cooktop, in particular an induction cooktop, wherein in particular accessory units for the cooktop, such as for example a sensor unit for the external measurement of a temperature of an item of cookware and/or a food to be cooked, can also be encompassed by the cooking system. For example, the cooking system could have at least one cooktop object which, in particular, could be a subassembly of a cooktop. The cooktop object could have, for example, at least one control unit and/or at least one user interface and/or at least one housing unit and/or at least one heating unit and/or at least one extractor fan unit and/or at least one control electronics unit for the heating unit. It would also be conceivable that the cooking system has at least one cooktop. It would be conceivable that the positioning plate could be configured as a cooktop plate of the cooktop.

A “positioning plate” is intended to be understood to mean at least one, in particular plate-like, unit which is provided in at least one operating state for positioning at least one item of cookware and/or for placing at least one food to be cooked for the purpose of heating. The positioning plate could be configured, for example, as a countertop or as a sub-region of at least one countertop, in particular of at least one kitchen countertop. Alternatively or additionally, the positioning plate could be configured as the cooktop plate of the cooktop. The positioning plate which is configured as the cooktop plate could form, in particular, at least one part of a cooktop external housing and could form at least in large part the cooktop external housing, in particular together with at least one external housing unit to which the positioning plate which is configured as the cooktop plate could be connected, in particular in at least one installed state. The positioning plate could be formed, for example, at least in large part from glass and/or from glass ceramic and/or from Neolith and/or from Dekton and/or from wood and/or from marble and/or from stone, in particular from natural stone, and/or from laminate and/or from metal and/or from plastic and/or from ceramic.

In particular, the cooking system has at least one heating unit, in particular induction heating unit, arranged below the positioning plate, and preferably has a plurality of heating units arranged below the positioning plate, in particular induction heating units.

The thermal distribution unit is provided to distribute waste heat which is supplied from the heating unit, in particular from the induction heating unit, and/or from the item of cookware to the positioning plate when the item of cookware is heated, in particular to distribute the waste heat relative to the positioning plate. In particular, the thermal distribution unit reduces a temperature gradient between the first region and at least one further region of the positioning plate. Advantageously, the thermal distribution unit reduces the temperature gradient in a manner which goes beyond a reduction which is implemented by at least one material of the positioning plate. In particular, the thermal distribution unit is provided to conduct heat from a hot region of the positioning plate to a cold region of the positioning plate, and thereby to reduce an existing temperature difference. The thermal distribution unit, in particular the part which is arranged between the positioning plate and the heating unit, and preferably the entire thermal distribution unit, in particular, is temperature-resistant to temperatures of at least 200° C. and preferably at least 250° C.

“Provided” is intended to be understood to mean specifically designed and/or equipped. An object being “provided for a specific function” is intended to be understood to mean that the object fulfills and/or performs this specific function in at least one use state and/or operating state.

It is also proposed that the part of the thermal distribution unit covers the entire surface area of the heating unit in the direction of the positioning plate. In particular, the heating unit is configured as an induction heating coil, wherein a surface area of the part of the thermal distribution unit can at least substantially correspond to a surface area of the induction heating coil and namely, in particular, relative to an external geometry of the induction heating coil. “At least substantially” is intended to be understood to mean in this context that a deviation from a predetermined value deviates, in particular, by less than 25%, preferably by less than 10%, and particularly preferably by less than 5% of the predetermined value. In particular, a particularly advantageous heat distribution can be achieved by means of such an embodiment. In particular, as a result, significant heat can be discharged from the generally very hot region of the heating units.

It is also proposed that the cooking system has at least one heat transfer element which connects the thermal distribution unit, in particular the part of the thermal distribution unit which is arranged between the positioning plate and the heating unit, to the positioning plate. In particular, the heat transfer element establishes a contact between the thermal distribution unit, and namely in particular between the part of the thermal distribution unit, and the positioning plate. Preferably, the heat transfer element compensates for any unevenness, in particular surface unevenness, of the thermal distribution unit and/or the positioning plate in order to establish, in particular, a thermal contact between the thermal distribution unit and the positioning plate which is preferably free of a fluid phase and namely preferably in the part of the thermal distribution unit which is arranged between the positioning plate and the heating unit. In particular, a particularly advantageous heat transfer between the positioning plate and the thermal distribution unit can be achieved by means of such an embodiment. In particular, an advantageous reduction in the thermal stresses and/or mechanical stresses caused by heat in the positioning plate can be reduced by means of such an embodiment. Moreover, a service life of the positioning plate can be extended by means of such an embodiment which, in particular, can further increase customer satisfaction.

It is also proposed that the heat transfer element fixes the thermal distribution unit to the positioning plate. It would be conceivable that the heat transfer element comprises at least one thermally conductive silicone which fixes the thermal distribution unit to the positioning plate. It would also be conceivable that the heat transfer element consists entirely of the thermally conductive silicone which fixes the thermal distribution unit to the positioning plate. In particular, the heat transfer element is configured as a thin-walled, thermally conductive layer which is provided, for example, to bond the thermal distribution unit to the positioning plate. In particular, the heat transfer element is arranged in a region, in particular in a volume, between the part of the thermal distribution unit, which is arranged between the positioning plate and the heating unit, and the positioning plate. In particular, the heat transfer element has a heat conductivity of, for example, at least 1 W/(m*k), advantageously at least 2 W/(m*k), particularly advantageously at least 10 W/(m*k), preferably at least 50 W/(m*k) and particularly preferably at least 350 W/(m*k). It can be achieved by means of such an embodiment that the heat transfer element undertakes both the fixing between the thermal distribution unit and the positioning plate and the establishing of an advantageous thermal contact. As a result, it is possible to dispense with additional components, and namely in particular additional components for fixing between the thermal distribution unit and the positioning plate. A cost efficiency can also be further improved thereby. Moreover, in particular, a particularly advantageous heat transfer between the positioning plate and the thermal distribution unit can be achieved by means of such an embodiment. In particular, the thermal stresses and/or the mechanical stresses caused by heat in the positioning plate can be advantageously reduced by means of such an embodiment. Moreover, a service life of the positioning plate can be extended by means of such an embodiment which, in particular, can further increase customer satisfaction.

It is also proposed that the part of the thermal distribution unit cannot be heated inductively. In particular, the part of the thermal distribution unit is not inductive. Preferably, the part of the thermal distribution unit consists at least in large part, and in particular entirely, of a non-inductive material. In particular, the part of the thermal distribution unit is not ferromagnetic. Preferably, the part of the thermal distribution unit consists at least to a large part, and in particular entirely, of a non-ferromagnetic material. Advantageously, the part of the thermal distribution unit is not electrically conductive. Preferably, the part of the thermal distribution unit consists at least in large part, and in particular entirely, of a non-electrically conductive material. In particular, an electrical conductivity of the part of the thermal distribution unit which is arranged between the positioning plate and the heating unit, for example, is at most 10⁻⁵ S/m, advantageously at most 10⁻⁶ S/m, particularly preferably at most 10⁻⁸ S/m, preferably at most 10⁻¹⁰ S/m and particularly preferably at most 10⁻¹⁶ S/m. The expression “at least in large part” is intended to be understood to mean in this context at least 55%, advantageously at least 65%, preferably at least 75%, particularly preferably at least 85% and particularly advantageously at least 95%. As a result, in particular, a particularly advantageous thermal conductivity can be provided. Moreover, as a result, it is possible to avoid negatively influencing an inductive heating process of the item of cookware. Moreover, electrical short circuits can be avoided thereby.

It is also proposed that the thermal distribution unit in the part which is arranged between the positioning plate and the heating unit consists at least in large part, and in particular entirely, of a thermally conductive ceramic material. In particular, the thermal distribution unit in the part which is arranged between the positioning plate and the heating unit consists at least in large part, and in particular entirely, of a material which has a thermal conductivity of, for example, at least 50 W/(m*k), advantageously at least 100 W/(m*k), particularly advantageously at least 200 W/(m*k), preferably at least 250 W/(m*k) and particularly preferably at least 350 W/(m*k). It would be conceivable that the thermal distribution unit in the part which is arranged between the positioning plate and the heating unit consists at least in large part, and in particular entirely, of aluminum oxide and/or aluminum nitride and/or silicon carbide and/or beryllium oxide. In particular, a particularly advantageous thermal conductivity can be provided thereby. Moreover, as a result, it is possible to avoid negatively influencing an inductive heating process of the item of cookware. Moreover, electrical short circuits can be avoided thereby.

It is also proposed that the part extends concentrically to the heating unit. In particular, the part of the thermal distribution unit which is arranged between the positioning plate and the heating unit has a geometry corresponding to an external geometry of the heating unit, in particular to an external geometry of the induction heating coil. It would be conceivable that the part of the thermal distribution unit which is arranged between the positioning plate and the heating unit, and in particular consists of a non-inductive material, has a larger surface area than the heating unit by at least 2%, advantageously by at least 5%, particularly preferably by at least 10%, preferably by at least 20% and particularly preferably by at least 25%, when viewed perpendicular to the heating unit. As a result, heat can be advantageously discharged from the in particular entire surface area of the heating unit.

For example, the thermal distribution unit could comprise at least silicon carbide and/or aluminum oxide and/or aluminum nitride and/or beryllium oxide in a region outside the part. A particularly advantageous heat distribution can take place if the thermal distribution unit comprises at least one thermally conductive metal material in a region outside the part. It would be conceivable that, outside the part which is arranged between the positioning plate and the heating unit, the thermal distribution unit consists at least in large part of copper and/or silver and/or steel and/or iron and/or aluminum or a different metal material which is temperature-resistant to temperatures of above 200° C.

It is also proposed that the cooking system has at least one temperature sensor which is provided to detect a temperature of an item of cookware which is positioned on the positioning plate. As a result, a temperature control of the item of cookware which is positioned on the positioning plate can be carried out in a particularly accurate manner. Moreover, safety can be improved thereby. In particular, the cooking system has a temperature sensor for each heating zone formed by a heating unit.

It is also proposed that the thermal distribution unit conducts heat to the temperature sensor from an item of cookware which is positioned on the positioning plate. As a result, it is possible to carry out a more accurate and in particular more rapid temperature measurement of a temperature of the item of cookware. Moreover, a more sensitive temperature control regarding the item of cookware can be carried out thereby. In particular, the thermal distribution unit conducts heat to the temperature sensor from an item of cookware which is positioned on the positioning plate, by the temperature sensor being in contact with the thermal distribution unit.

It is also proposed that at least one further part of the thermal distribution unit is arranged between the positioning plate and the temperature sensor. As a result, a recess on the thermal distribution unit can be dispensed with, which permits a more cost-effective embodiment of the thermal distribution unit. Moreover, it can be permitted thereby that the temperature sensor is fastened directly to the thermal distribution unit. This permits an embodiment as an assembly, which significantly simplifies an installation of the cooking system.

It is also proposed that the cooking system has at least one heat-conducting element which is arranged in a recess of the positioning plate and which is provided to conduct heat to the temperature sensor from an item of cookware which is positioned on the positioning plate. A particularly accurate and/or particularly rapid temperature measurement and/or temperature control relative to the temperature of the item of cookware can be undertaken by means of such an embodiment. For example, the heat transfer element could consist at least in large part, and in particular entirely, of aluminum oxide and/or aluminum nitride and/or silicon carbide and/or beryllium oxide. Also conceivable, however, would be a metal heat-conducting element which is arranged in a winding-free center of the induction heating coil and which consists at least in large part of copper and/or silver and/or steel and/or iron and/or aluminum.

It is also proposed that the thermal distribution unit has at least has one recess for at least partially receiving the temperature sensor. Alternatively or additionally, the recess could be provided, for example, for at least partially receiving, and in particular entirely receiving, the heat-conducting element. Alternatively or additionally, would also be conceivable that the thermal distribution unit has at least one further recess for at least partially receiving the heat-conducting element. As a result, in particular, the heat-conducting element and/or the temperature sensor can be fixed in a particularly space-saving manner.

It is also proposed that the cooking system has a plurality of heating units, in particular induction heating units, wherein the thermal distribution unit for each of the heating units has a part which is arranged between the positioning plate and the respective heating unit. As a result, a plurality of heating zones can be advantageously provided by means of the heating units, which permits cooking with items of cookware on a plurality of heating zones.

The invention further relates to a method for installing a cooking system, in particular an induction cooking system, comprising at least one positioning plate, comprising at least one heating unit which is arranged below the positioning plate and comprising at least one thermal distribution unit for distributing heat.

In order to achieve improved properties regarding heat distribution, in particular regarding a long service life of the positioning plate, it is proposed that at least one part of the thermal distribution unit is arranged between the positioning plate and the heating unit.

The cooking system and the method for installing a cooking system in this case is not intended to be limited to the above-described use and embodiment. In particular, the cooking system and the method for installing a cooking system can have a number of individual elements, components and units which differs from a number mentioned herein, for fulfilling a mode of operation described herein.

Further advantages emerge from the following description of the drawing. Four exemplary embodiments of the invention are shown in the drawing. The drawing, the description and the claims contain numerous features in combination. The person skilled in the art will also expediently consider the features individually and combine them to form further meaningful combinations.

In the drawing:

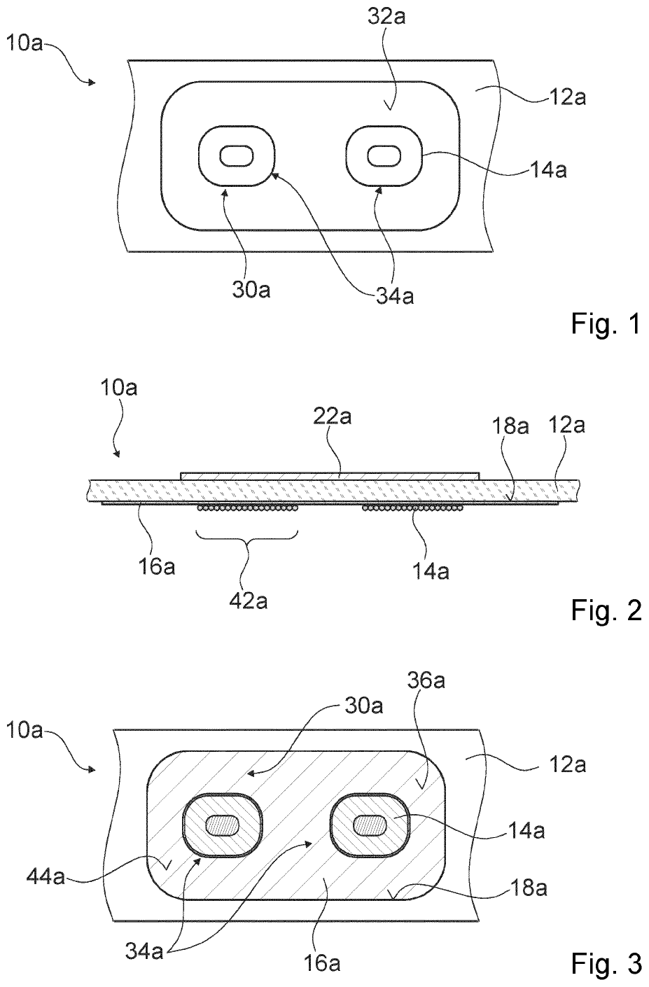

FIG. 1 shows a cooking system which is embodied as an induction cooking system, comprising a positioning plate, in a simplified plan view,

FIG. 2 shows a part of the cooking system comprising a heating unit which is arranged below the positioning plate and comprising a thermal distribution unit, a part thereof being arranged between the positioning plate and the heating unit, in a simplified sectional view,

FIG. 3 shows a part of the cooking system comprising the positioning plate, in a partially transparent view,

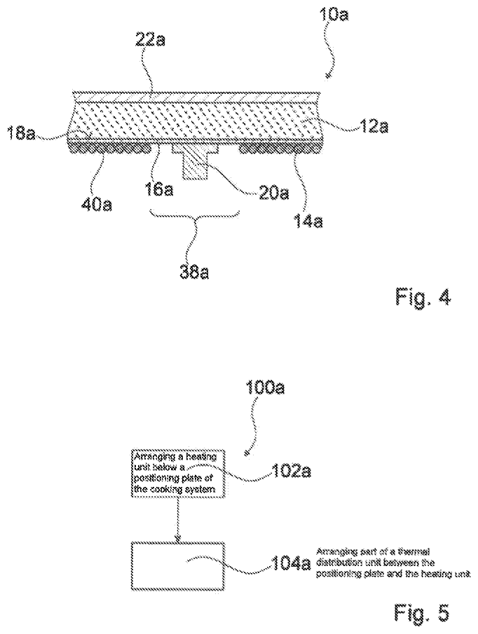

FIG. 4 shows a part of the cooking system comprising a temperature sensor, in a simplified sectional view,

FIG. 5 shows a flow diagram of a method for installing a cooking system,

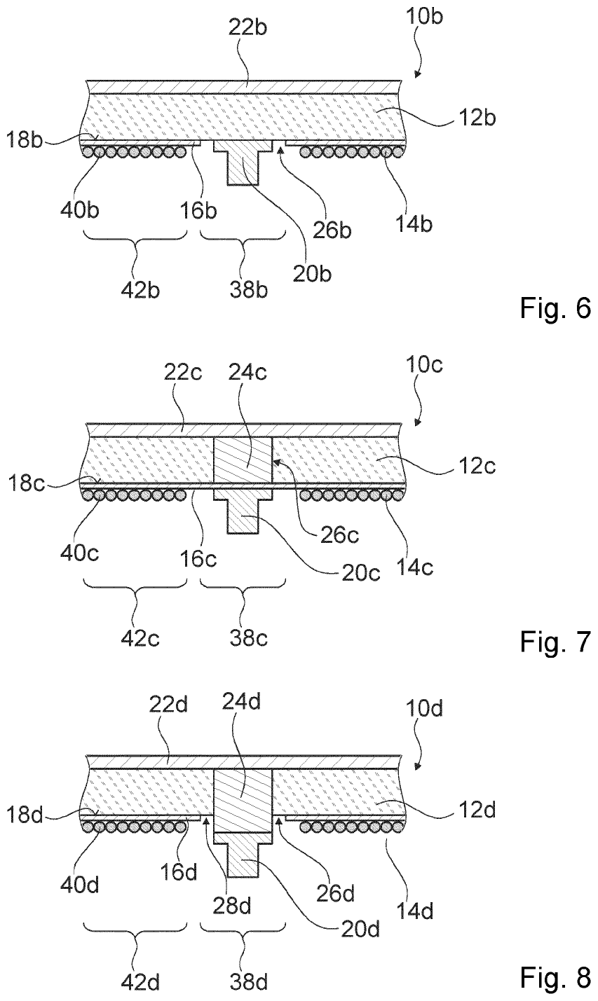

FIG. 6 shows a cooking system of a further exemplary embodiment comprising a positioning plate, comprising a thermal distribution unit and comprising a temperature sensor, in a simplified sectional view,

FIG. 7 shows a cooking system of a further exemplary embodiment comprising a positioning plate, comprising a thermal distribution unit and comprising a temperature sensor, in a simplified sectional view and

FIG. 8 shows a cooking system of a further exemplary embodiment comprising a positioning plate, comprising a thermal distribution unit and comprising a temperature sensor, in a simplified sectional view.

Of the objects which are repeatedly present, only one is provided in each case with a reference sign in the figures.

FIG. 1 shows a cooking system 10a which is embodied as an induction cooking system. The cooking system 10a has a positioning plate 12a. In an installed state, the positioning plate 12a forms a visible surface 32a which in the installed state is arranged, in particular, facing a user. The positioning plate 12a is provided for positioning an item of cookware 22a in a positioning region 30a for heating (see FIGS. 1 to 3). In the present exemplary embodiment, the positioning plate 12a is configured as a countertop. The positioning plate 12a which is configured as a countertop consists in large part, and in particular entirely, of natural stone.

The cooking system 10a has at least one heating unit 14a (see FIGS. 1 to 3) which is arranged below the positioning plate 12a. In the present exemplary embodiment, the cooking system 10a has two heating units 14a. Alternatively, the cooking system 10a could have, for example, a greater number of heating units 14a, such as for example at least two, in particular at least four, advantageously at least eight, particularly advantageously at least twelve, and preferably a multiplicity of heating units 14a, wherein all of the heating units are arranged below the positioning plate 12a. The heating units 14a could be arranged, for example, in the form of a matrix. In the present exemplary embodiment, each of the two heating units 14a defines a heating zone 34a.

The cooking system 10a also has a thermal distribution unit 16a for distributing heat. The thermal distribution unit 16a is provided to distribute heat in an operating state of the cooking system 10a in which at least one item of cookware 22a is heated by means of at least one of the heating zones 34a. When the item of cookware 22a is heated by means of a heating zone 34a, which takes place in particular inductively, for example, waste heat is produced from the heated item of cookware 22a. This heat, which significantly heats up the positioning plate 12a in the positioning region 30a and namely in the region of the heating zones 34a, leads to thermal stresses in the positioning plate 12a. The thermal stresses occur, in particular, due to a temperature difference in the positioning plate 12a, wherein the positioning plate is significantly heated up in the positioning region 30a and namely in the region of the heating zones 34a and is relatively cold in an edge region 36a of the positioning plate 12a. The thermal distribution unit 16a is provided to compensate for this temperature difference by distributing heat.

At least one part of the thermal distribution unit 16a is arranged between the positioning plate 12a and the heating unit 14a (see FIG. 2). FIG. 2 shows relative thereto a heating unit 14a which comprises a circular induction heating coil 40a and which has a free central region 38a, in a sectional view. The thermal distribution unit 16a has for each of the heating units 14a a part which is arranged between the positioning plate 12a and the respective heating unit 14a.

The elements shown in the figures, and namely in particular in the sectional views, are not illustrated to scale, wherein some of the elements could be shown larger for the purposes of illustration and/or could be shown smaller for the sake of clarity.

The part of the thermal distribution unit 16a entirely covers the heating unit 14a in the direction of the positioning plate 12a. FIG. 2 shows an overlapping region 42a in which in the present exemplary embodiment of the invention, and namely in the operating state, at least the item of cookware 22a, the positioning plate 12a, the thermal distribution unit 16a and the heating unit 14a are arranged so as to overlap.

The cooking system also has a heat transfer element 18a. The heat transfer element 18a connects the thermal distribution unit 16a to the positioning plate 12a. In particular, the thermal distribution unit 16a connects the part of the thermal distribution unit 16a to the positioning plate 12a.

The heat transfer element 18a establishes a thermal contact between the thermal distribution unit 16a and the positioning plate 12a. In particular, the heat transfer element 18a establishes a thermal contact between the part of the thermal distribution unit 16a and the positioning plate 12a. Additionally, the heat transfer element 18a establishes a thermal contact between the edge region 36a of the thermal distribution unit 16a and the positioning plate 12a.

In the present exemplary embodiment, the heat transfer element 18a is embodied as a thin layer and comprises at least one thermally conductive silicone. The heat transfer element 18a is thus not shown in detail.

The heat transfer element 18a fixes the thermal distribution unit 16a to the positioning plate 12a. The heat transfer element 18a establishes an adhesively bonded connection between the thermal distribution unit 16a and the positioning plate 12a. In particular, the heat transfer element 18a establishes an adhesively bonded connection between the part of the thermal distribution unit 16a and the positioning plate 12a. Additionally, the heat transfer element 18a establishes an adhesively bonded connection between the edge region 36a of the thermal distribution unit 16a and the positioning plate 12a.

The thermal distribution unit 16a in the part is formed at least in large part, and in the present exemplary embodiment entirely, from a thermally conductive ceramic material. In the present exemplary embodiment, the part of the thermal distribution unit 16a which is arranged between the positioning plate 12a and the heating unit 14a consists entirely of silicon carbide.

In the present exemplary embodiment, the part of the thermal distribution unit 16a which is arranged between the positioning plate 12a and the heating unit 14a extends concentrically to the heating unit 14a. The part of the thermal distribution unit 16a which is arranged between the positioning plate 12a and the heating unit 14a cannot be heated inductively. The part of the thermal distribution unit 16a which is arranged between the positioning plate 12a and the heating unit 14a is not electrically conductive. The part of the thermal distribution unit 16a which is arranged between the positioning plate 12a and the heating unit 14a is not ferromagnetic.

The thermal distribution unit 16a comprises at least one thermally conductive metal material in a region 44a outside the part, and in particular in the edge region 36a. In the present exemplary embodiment of the invention, the thermal distribution unit 16a is formed from aluminum in a region 44a outside the part which is arranged between the positioning plate 12a and the heating unit 14a, and in particular in the edge region 36a.

Thus the thermal distribution unit 16a is an integrally configured structural unit which is formed from different materials in the part which is arranged between the positioning plate 12a and the heating unit 14a, and in the region 44a outside the part, and in particular in the edge region 36a.

The cooking system additionally comprises at least one temperature sensor 20a. In particular, the cooking system 10a has a temperature sensor 20a for each heating zone 34a formed by at least one heating unit 14a. The temperature sensor 20a is provided to detect a temperature of an item of cookware 22a which is positioned on the positioning plate 12a. The temperature sensor 20a is configured as an NTC thermistor.

In the present exemplary embodiment of the invention, the thermal distribution unit 16a conducts heat to the temperature sensor 20a from the item of cookware 22a which is positioned on the positioning plate 12a. This is because at least a further part of the thermal distribution unit 16a is arranged between the positioning plate 12a and the temperature sensor 20a.

In FIG. 5 a flow diagram is shown of a method 100a for installing a cooking system 10a, in particular an induction cooking system. The method 100a comprises at least one method step 102a and at least one further method step 104a.

In the method step 102a, the cooking system 10a is provided with the positioning plate 12a, with the at least one heating unit 14a which is arranged below the positioning plate 12a, and with the thermal distribution unit 16a for distributing heat.

In the method step 104a, at least one part of the thermal distribution unit 16a is arranged between the positioning plate 12a and the heating unit 14a.

Three further exemplary embodiments of the invention are shown in FIGS. 6 to 8. The following descriptions are substantially limited to the differences between the exemplary embodiments, wherein relative to components, features and functions remaining the same, reference can be made to the description of the exemplary embodiment of FIGS. 1 to 5. In order to differentiate between the exemplary embodiments, the letter a in the reference signs of the exemplary embodiment in FIGS. 1 to 5 is replaced in each case by the letters b, c and d in the reference signs of the exemplary embodiments of FIGS. 6 to 8. Relative to components denoted the same, in particular relative to components having the same reference signs, in principle reference can also be made to the drawings and/or the description of the exemplary embodiment of FIGS. 1 to 5.

FIG. 6 shows a part of a further exemplary embodiment of a cooking system 10b in a sectional view which is not to scale. The cooking system 10b is configured as an inductive cooking system. The cooking system 10b has a positioning plate 12b. The cooking system 10b has a heating unit 14b which is arranged below the positioning plate 12b.

The cooking system 10b also has a thermal distribution unit 16b for distributing heat. The thermal distribution unit 16b is provided to distribute heat in an operating state of the cooking system 10b in which at least one item of cookware 22b is heated.

The cooking system 10b additionally comprises at least one temperature sensor 20b. The thermal distribution unit 16b has a recess 28b. The recess 28b is provided for at least partially receiving the temperature sensor 20b. In an installed state, the recess 28b is arranged centrally relative to the heating unit 14b and namely relative to a central region 38b of the heating unit 14b.

FIG. 7 shows a part of a further exemplary embodiment of a cooking system 10c in a sectional view which is not to scale. The cooking system 10c is embodied as an induction cooking system. The cooking system 10c has a positioning plate 12c. The cooking system 10c has a heating unit 14c which is arranged below the positioning plate 12c.

The cooking system 10c also has a thermal distribution unit 16c for distributing heat. The thermal distribution unit 16c is provided to distribute heat in an operating state of the cooking system 10c in which at least one item of cookware 22c is heated.

The cooking system 10c additionally comprises at least one temperature sensor 20c. The cooking system 10c of the present exemplary embodiment of the invention also has at least one heat-conducting element 24c. The heat-conducting element 24c is arranged in a recess 26c of the positioning plate 12c. The recess 26c of the positioning plate 12c encloses the heat-conducting element 24c in a form-fit manner in the example shown. The heat-conducting element 24c is provided to conduct heat to the temperature sensor 20c from an item of cookware 22c which is positioned on the positioning plate 12c.

FIG. 8 shows a part of a further exemplary embodiment of a cooking system 10d in a sectional view which is not to scale. The cooking system 10d is configured as an inductive cooking system. The cooking system 10d has a positioning plate 12d. The cooking system 10d has a plurality of heating units 14d which are arranged below the positioning plate 12d, only one thereof being shown.

The cooking system 10d also has a thermal distribution unit 16d for distributing heat. The thermal distribution unit 16d is provided to distribute heat in an operating state of the cooking system 10d in which at least one item of cookware 22d is heated.

The cooking system 10d additionally comprises at least one temperature sensor 20d. The thermal distribution unit 16d has a recess 28d. The recess 28d is provided for at least partially receiving the temperature sensor 20d. In an installed state, the recess 28d is arranged centrally relative to the heating unit 14d and namely relative to a central region 38d of the heating unit 14d.

The cooking system 10d of the present exemplary embodiment of the invention also has at least one heat-conducting element 24d. The heat-conducting element 24d is arranged in a recess 26d of the positioning plate 12d. The recess 26d of the positioning plate 12d encloses the heat-conducting element 24d in a form-fit manner in the example shown. The heat-conducting element 24d is provided to conduct heat to the temperature sensor 20d from the item of cookware 22d which is positioned on the positioning plate 12d.

The recess 28d is additionally provided for at least partially receiving the heat-conducting element 24d.

### REFERENCE SIGNS

10 Cooking system
12 Positioning plate
14 Heating unit
16 Thermal distribution unit
18 Heat transfer element
20 Temperature sensor
22 Item of cookware
24 Heat-conducting element
26 Recess
28 Recess
30 Positioning region
32 Visible surface
34 Heating zone
36 Edge region
38 Central region
40 Induction heating coil
42 Overlapping region
44 Region
100 Method
102 Method step
104 Method step

1-15. (canceled)

16. A cooking system, in particular an induction cooking system, said cooking system comprising:
a positioning plate;
a heating unit arranged below the positioning plate; and
a thermal distribution unit designed to distribute heat, said thermal distribution unit comprising a part arranged between the positioning plate and the heating unit.

17. The cooking system of claim 16, wherein the part of the thermal distribution unit covers an entire surface area of the heating unit in a direction of the positioning plate.

18. The cooking system of claim 16, further comprising a heat transfer element designed to connect the thermal distribution unit, in particular the part of the thermal distribution unit, to the positioning plate.

19. The cooking system of claim 18, wherein the heat transfer element fixes the thermal distribution unit to the positioning plate.

20. The cooking system of claim 16, wherein the part of the thermal distribution unit is designed such as to be incapable of being heated inductively.

21. The cooking system of claim 16, wherein the part of the thermal distribution unit is made substantially of a thermally conductive ceramic material.

22. The cooking system of claim 16, wherein the part of the thermal distribution unit extends concentrically to the heating unit.

23. The cooking system of claim 16, wherein the thermal distribution unit comprises a thermally conductive metal material in a region outside the part of the thermal distribution unit.

24. The cooking system of claim 16, further comprising a temperature sensor designed to detect a temperature of an item of cookware which is positioned on the positioning plate.

25. The cooking system of claim 24, wherein the thermal distribution unit conducts heat to the temperature sensor from the item of cookware on the positioning plate.

26. The cooking system of claim 24, wherein the thermal distribution unit comprises a further part arranged between the positioning plate and the temperature sensor.

27. The cooking system of claim 24, further comprising a heat-conducting element arranged in a recess of the positioning plate and designed to conduct heat to the temperature sensor from the item of cookware on the positioning plate.

28. The cooking system of claim 24, wherein the thermal distribution unit includes a recess for at least partially receiving the temperature sensor.

29. The cooking system of claim 16, further comprising a plurality of said heating unit, wherein the thermal distribution unit comprises for each of the heating units a part which is arranged between the positioning plate and a respective one of the heating units.

30. The cooking system of claim 16, wherein the heating unit is an induction heating unit.

31. A method for installing a cooking system, said method comprising: arranging a heating unit below a positioning plate of the cooking system; and arranging a part of a thermal distribution unit of the cooking system between the positioning plate and the heating unit.

32. The method of claim 31, further comprising covering an entire surface area of the heating unit by the part of the thermal distribution unit in a direction of the positioning plate.

33. The method of claim 31, further comprising connecting the thermal distribution unit to the positioning plate via a heat transfer element.

34. The method of claim 31, further comprising placing the part of the thermal distribution unit concentrically to the heating unit.

35. The method of claim 31, further comprising:
arranging a heat-conducting element of the cooking system in a recess of the positioning plate; and
arranging a further part of the thermal distribution unit between the positioning plate and a temperature sensor of the cooking system to conduct heat to the temperature sensor from an item of cookware which is positioned on the positioning plate.
